(19) United States
(12) Patent Application Publication
(10) Pub. No.: US 2010/0304323 A1
(43) Pub. Date: Dec. 2, 2010

(54) Dental Color Key

(76) Inventors: Gottfried Rohner, Altstatten (CH); Diethard Bertsch, Gofis (AT); Michael Brotzge, Koblach (AT)

Correspondence Address: John C. Thompson, 69 Grayton Road, Tonawanda, NY, 14150, US

(21) Appl. No.: 12/771,873

(22) Filed: Apr. 30, 2010

(30) Foreign Application Priority Data
May 29, 2009 (EP) EP 09 161 608.6

(51) Int. Cl. A61C 19/10

(52) U.S. Cl. 433/26

(57) ABSTRACT

The invention relates to a dental color key comprising at least two different color patterns or samples with different tooth colors. The entire surface area of the color key (10) is smaller than the buccal and/or labial surface area, that is to say the vestibular surface area of two teeth, and the color patterns or samples (12) are attached adjacent to one another and particularly mounted to one single tooth.

### CROSS-REFERENCE TO RELATED APPLICATIONS

This application claims foreign priority benefits under 35 U.S.C. §119(a)-(d) from European Patent Application EP 09 161 608.6 filed May 29, 2009

### TECHNICAL FIELD

The invention relates to a dental color key having at least two color patterns or samples with different tooth colors.

### BACKGROUND OF THE INVENTION

Dental color keys have been known for a long time. The color key according to U.S. Pat. No. 4,541,801 serves as an example. With a color key of this type, at least two different color patterns or samples with varying tooth colors are used and placed next to a neighboring tooth of the tooth to be restored. Each color sample typically has about the surface area of a tooth and often also has a curvature of its surface similar to a tooth.

Some more recent examples for dental color keys of this kind are solutions or approaches known from U.S. Pat. No. 5,653,589 and EP 1 002 502 A2. These solutions or approaches in fact represent improvements as the manageability of individual color patterns or samples and for this reason the possibility for the dentist to judge a color sample in relation to a natural tooth is improved. However, the result of comparison strongly depends on the subjective sensation or personal opinion of the dentist, and further for example also on the conditions of light exposure especially if a color sample of the color key is placed next to a tooth.

In particular the curvature of the color patterns or samples, which curvature is regarded as desired, requires a distinct three-dimensional design or configuration of the color patterns or samples such that a small color rod clearly projects even if it is placed or held next to a tooth. This already requires different light conditions as color sample and tooth then never are arranged on the same optical plane.

In order to exclude human influences on the judgement, it has been proposed to acquire an existing tooth color by use of a dental camera and to electronically select the suitable tooth color such as A2, A3 etc. For such a solution however it is necessary to perform complex calibration steps. An electronic color detection device of this kind is rather costly and therefore comes into consideration only with major dental practices.

The color keys known, purely for spatial reasons, typically merely comprise the most popular or established tooth colors that for example comprise no bleaching colors and even more no gingival colors.

### OBJECTS AND SUMMARY OF THE INVENTION

On the other hand, the invention is based on the object to produce a dental color key having at least two color patterns or samples with different tooth colors, which color key is optimized with regard to color comparability, but nevertheless can be manufactured well-priced and nevertheless offers the possibility to cover a comparatively large spectrum.

This object is inventively solved by the dental color key comprising at least two color patterns or samples with different tooth colors, characterized in that the entire surface area of the color key is smaller than the buccal and/or labial surface, that is to say the vestibular surface of two teeth, and that the color patterns or samples are adjacent to one another

The color key according to the invention is characterized by the fact that it comprises several, in particular a plurality of color patterns or samples, and in particular that it can be arranged in the peripheral region of a single adjacent tooth that is to be determined in terms of color. In this way, the regions of the tooth next to the color key can already be used for comparison purposes.

Due to the close proximity of a plurality of color patterns or samples with the tooth, the comparability can be clearly improved, because due to the immediate comparison, the comparability is considerably improved compared to the case that different small color rods are placed next to a tooth one after another out of one's memory.

Due to the fact that the color patterns or samples are notably small, said patterns or samples may also be attached close to the surface of the tooth that is to be defined. The extent of projection is not noteworthy, so that it may be assumed that the color patterns or samples are substantially arranged in the same plane just as the surface of the respective tooth.

According to the invention, however, it is preferred to attach or affix the miniaturized color key to a neighboring tooth, said attachment preferably being selected such that both central regions and marginal regions of the tooth to be determined are visible besides the miniaturized color key.

For example, there is the possibility to arrange the color key between teeth of the lower and upper jaw and to use it for the color comparison with the neighboring tooth. It is also possible to provide the inventive color key with a clip by means of which the color key may be attached at various positions of the dental lamella. The color key according to the invention is preferably small and lightweight and has a thickness of less than 6 mm, preferably 0.5 mm. The color patterns or samples preferably are within a grid or raster, particularly preferably within a matrix such that an easier allocation is possible.

This is also true if color options such as bleaching colors or gingival colors are provided at opposing lateral edges.

The standard color key preferably comprises four, in particular 16 color patterns or samples, next to which ridges with bleaching colors and gingival colors are attached if required.

An advantageous embodiment of the inventive color key provides that the color key occupies a surface area that is smaller than the vestibular surface area of a tooth. This particularly applies for incisors, that is to say for the labial surface area of incisors.

Even if it is preferred that 16 different color patterns or samples are realized in one color key, it is to be understood that in a modified embodiment any other number of color patterns or samples can be realized as well. This in particular applies if the color patterns or samples are not arranged in a discrete manner but continuously merge. Basically, it is also possible to leave a recess in the central part of the color key through which the vestibular surface is visible in order to keep the marginal distance small.

The color patterns or samples of the color key are preferably attached next to or on top of one another in a densely packed manner at a single tooth. This also provides for an especially favorable comparability due to the close distances. Alternatively, parting lines, in particular separating strips, may be provided that permit an optical separation of the individual color patterns or samples that either merge or run together continuously or that adjoin one another in a discrete manner.

The color patterns or samples of the color key may be realized in any suitable manner and may be supported for example by an opaque and/or dentin material.

A particular favorable refinement provides that the dental color key occupies a surface area that is smaller than a buccal and/or labial surface of a tooth.

A particular favorable refinement provides that the color key comprises at least four, in particular sixteen different known dental color patterns or samples.

A particular favorable refinement provides that the color patterns or samples of the color key are built from a restoration material that has been dyed according to the tooth color.

A particular favorable refinement provides that the color patterns or samples of the color key comprise different color shades and opacities.

A particular favorable refinement provides that the color patterns or samples of the color key correspond to similar tooth colors of a color shade.

A particular favorable refinement provides that the color key comprises at least one color sample that corresponds to a bleach color and/or to a color of the gums or gingiva.

A particular favorable refinement provides that the color key may be arranged or is releasably mounted in the peripheral region of a tooth that is to be analyzed.

A particular favorable refinement provides that the color key forms part of a spacer that in particular interacts with a camera.

A particular favorable refinement provides that the color key and the buccal and/or labial surface area of the tooth that is to be analyzed, substantially extend into the same plane.

A particular favorable refinement provides that the color key is releasably mounted—in particular mechanically or adhesively—on at least one tooth or between at least two teeth of the upper jaw and the lower jaw.

A particular favorable refinement provides that the color key has a thickness of 0.01 mm to 6 mm and in particular is formed as a printed foil or film.

A particular favorable refinement provides that the foil or film is provided with an adhesive that can be removed from a tooth surface without leaving behind any remainders, i.e. in a residue-free manner.

A particular favorable refinement provides that at least the color patterns or samples at least partially are made from ceramics.

A particular favorable refinement provides that at least the color patterns or samples at least partially are made from a dental composite material.

A particular favorable refinement provides that the color patterns or samples continuously merge or run together.

A particular favorable refinement provides that the color patterns or samples do not continuously merge or run together but are represented in a discrete manner.

### BRIEF DESCRIPTION OF THE FIGURES

Further advantages, details and features emerge from the following description of several exemplary embodiments of a dental color key according to the invention on the basis of the drawings, in which:

FIG. 1 shows a perspective view of an embodiment of an inventive color key in schematic representation;

FIG. 2 shows a further embodiment of an inventive dental color key in a top view;

FIG. 3 shows a top view of an inventive dental color key after having been attached to a tooth;

FIG. 4 shows a top view of a further embodiment of an inventive dental color key after having been attached to a tooth;

FIG. 5 shows a modified arrangement of an inventive dental color key;

FIG. 6 shows a dental color key in a further embodiment, said dental color key being configured as a small plate or disk;

FIG. 7 shows a multiple arrangement of dental color keys that are formed like a film and that are wound up on a roll;

FIG. 8 shows a dental color key according to FIG. 6 shown from the rear side and having a fastening clip;

FIG. 9 shows a different fastening device for a dental color key; and

FIG. 10 shows a tooth color analyzing device for use with an inventive dental color key.

### DETAILED DESCRIPTION

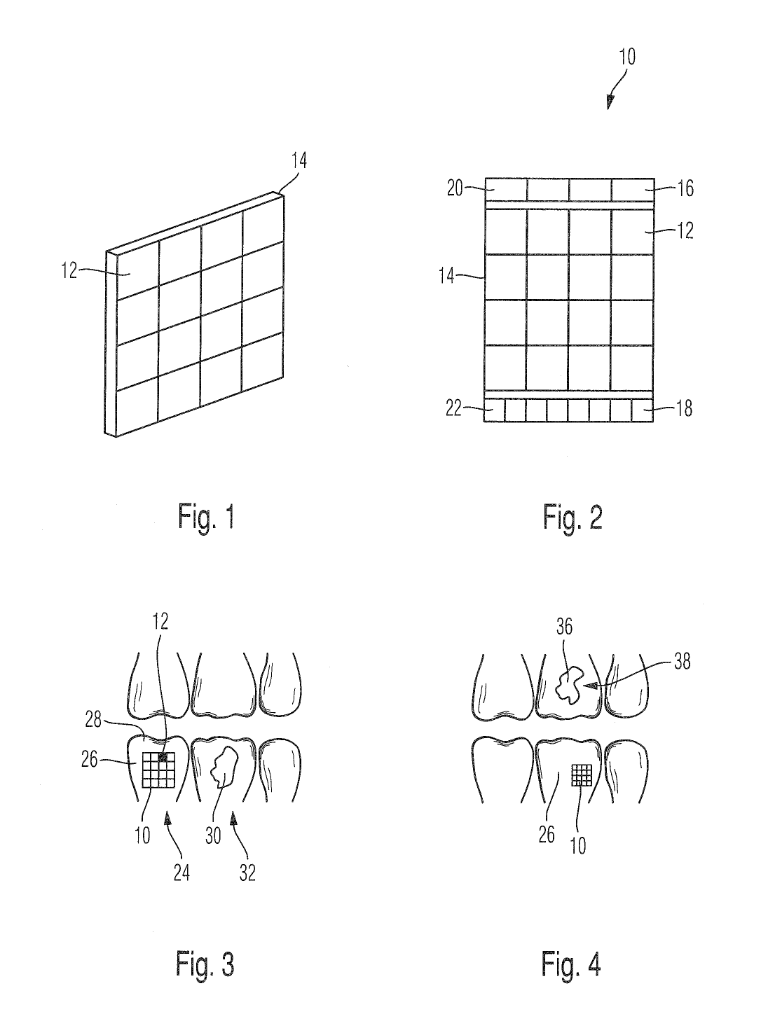

The inventive dental color key 10 represented in FIG. 1 comprises a plurality, i.e. 16, color patterns 12 that are arranged in the manner of a matrix. Each color pattern corresponds to a commercial or standard tooth color such as A2, A3, A4 etc., and tooth colors similar to one another are preferably arranged adjacent to one another.

The color patterns 12 are fixedly mounted on the small plate shaped color key. In this respect, the color key comprises a thin base body 14 that is suitable for being mounted on a tooth, namely on the vestibular surface area thereof. The mounting can be effected either with the aid of an adhesive that retains the base body 14 in a manner such that it at least does not come loose in case of a soft nudge with the tongue, or with a clip that overlaps the tooth, preferably an incisor, and as a result provides for the desired clamping effect.

It is also possible to design the base body flexible to some extent such that it may better adapt itself to the slightly curved surface of the incisor. Preferably, the base body is notably smaller than a tooth, for example half the width thereof, and significantly thinner, for example more than one decimal power. As a result, the inventive color key 10 rests on the tooth with its entire face, and it is possible to enable an immediate comparison between the color pattern 12 and the tooth. In this respect, sufficient free areas of the vestibular surface of the tooth remain, whereas it is to be understood that a neighboring tooth may also be easily compared to the inventive color key 10.

The color patterns 12 of the color key 10 may be built from a restoration material that has been dyed according to the tooth color. The color patterns 12 of the color key 10 may also comprise different color shades and opacities. It is also possible to arrange the color patterns 12 of the color key 10 in such a manner that they continuously merge or run together.

While FIG. 1 shows a color key having 16 color patterns, the color key of a further embodiment of the present invention, as shown in FIG. 2, includes 28 color patterns. Additionally to the 16 stock color patterns 12 this color key includes four color patterns corresponding to four bleach colors, respectively, as well as eight color patterns 18 corresponding to eight gingival colors, respectively. These color patterns 12 and 18 are arranged in the embodiment shown in FIG. 2 by means of separate base bodies 20 and 22, wherein both of the base bodies 20 and 22 are kept pluggable on the base body 14. It is also possible and conceivable to realize the color key 16 as an entity, which achievement may be also more inexpensive as the embodiment shown in FIG. 2.

By the elected longitudinal arrangement of the dental color key according to FIG. 2, it is ensured that the edge distance of also the internal color patterns 12 is not to large and in addition, that the color key 10 is not tower above the vestibular surface of the tooth. For this purpose, it is preferred that the color key 10 is vertical attached, as shown in FIG. 2. Further, it is preferred that the base body 22 is assembled in such a way that the color patterns 18 corresponding to gingival colors are arranged apical.

FIG. 3 shows in which manner an inventive color key 10 may be mounted on a tooth 24. In the represented embodiment, the color key 10 is centrally mounted on the vestibular face 26 of the tooth such that free faces 28 surround the color key 10 at all sides thereof.

By means of an optical comparison—either direct or with auxiliary equipment—one manages to detect the match of a color pattern 12 with a surface 30 of a neighboring tooth 32 such that the tooth color for this surface area 30 is determined and thus detected.

It is particularly favorable if in case of a photographic support, this is realized with the same photograph, as no calibration is then required but the respective tooth color is detected automatically.

In FIG. 4 it is represented in which a color key 10 is used in order to detect an area 36 of an antagonist tooth 38. In the embodiment represented, the color key 10 is distally mounted on the vestibular surface of the tooth such that there are comparatively large free or open areas 26 at three sides that are particularly well suitable for assessing the tooth color.

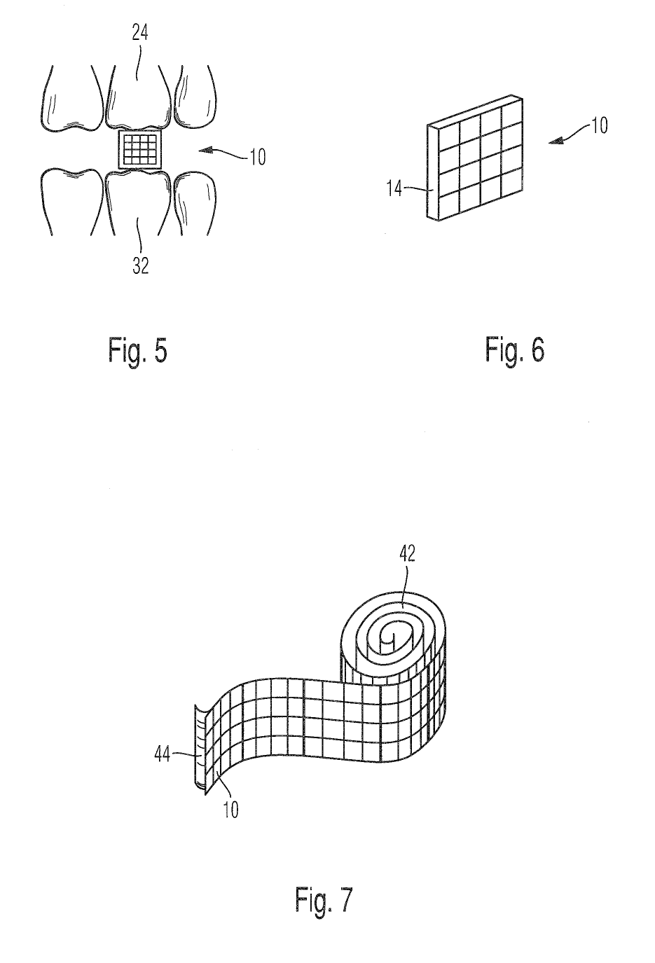

FIG. 5 shows a modified embodiment of an inventive dental color key 10, which embodiment allows to assess as well as possible both a lower jaw tooth and its upper jaw antagonist. For this reason, a dental color key according to FIG. 9 is clipped on both the lower jaw and the upper jaw and thus allows judging or assessing both the tooth 24 and the tooth 32 in a similar manner.

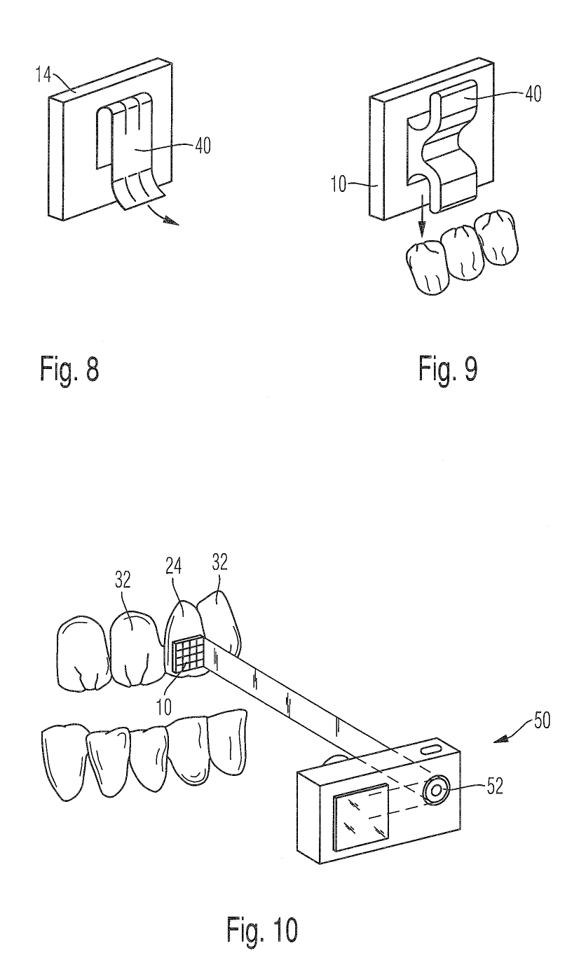

FIG. 6 shows that the inventive dental color key 10 with its base body 14 may have the shape of a thin plate that according to FIG. 8 may be well clipped on a tooth and located in position there with the aid of a clip 40 that is mounted on the rear side of the thin plate.

A modified embodiment of an inventive dental color key is represented in FIG. 7. In this case, the dental color key 10 is mounted on a roll 42 like an adhesive label, and a common carrier film 44 is designed in such a manner that the dental color key 10 that is coated with an adhesive surface on its back side, may easily be separated from the carrier film 44.

FIG. 9 shows a double clip that allows for the specific arrangement of the dental color key according to FIG. 5, said double clip 40 being capable of engaging over both a lower jaw incisor and an upper jaw incisor as can be seen from the drawing, and keeping both teeth in a defined distance from one another.

FIG. 10 represents a dental analyzing device 50 that takes and stores a picture of the dental color key 10 together with the tooth 24 and typically also of the neighboring teeth 32 via a lens 52 having a CCD sensor.

As a result, a calibration of the dental analyzing device 50 can be avoided in a particularly favorable manner.

According to a further embodiment of the present invention which is not shown in the FIGS. 1 to 10, it is also possible to arrange the color key on a spacer that in particular interacts with a dental camera.

While a preferred form of this invention has been described above and shown in the accompanying drawings, it should be understood that applicant does not intend to be limited to the particular details described above and illustrated in the accompanying drawings, but intends to be limited only to the scope of the invention as defined by the following claims. In this regard, the terms as used in the claims are intended to include not only the designs illustrated in the drawings of this application and the equivalent designs discussed in the text, but are also intended to cover other equivalents now known to those skilled in the art, or those equivalents which may become known to those skilled in the art in the future.

What is claimed is:

1. A dental color key comprising at least two color patterns or samples with different tooth colors, characterized in that the entire surface area (26) of the color key (10) is smaller than the buccal and/or labial surface, that is to say the vestibular surface (26) of two teeth, and that the color patterns or samples (12) are adjacent to one another.

2. The dental color key as claimed in claim 1, wherein the color key (10) occupies a surface area (26) that is smaller than a buccal and/or labial surface area (26) of a tooth.

3. The dental color key as claimed in claim 1, wherein the color key (10) comprises at least four, in particular sixteen different known dental color patterns or samples (12).

4. The dental color key as claimed in claim 1, wherein the color patterns or samples (12) of the color key (10) are built from a restoration material that has been dyed according to the tooth color.

5. The dental color key as claimed in claim 1, wherein the color patterns or samples (12) of the color key (10) comprise different color shades and opacities.

6. The dental color key as claimed in claim 1, wherein the color patterns or samples (12) of the color key (10) correspond to similar tooth colors of a color shade.

7. The dental color key as claimed in claim 1, wherein the color key (10) comprises at least one color sample corresponding to a bleach color (16) and/or to a color of the gums or gingiva.

8. The dental color key as claimed in claim 1, wherein the color key (10) may be arranged or is releasably mounted in the peripheral region of a tooth that is to be analyzed.

9. The dental color key as claimed in claim 1, wherein the color key (10) forms part of a spacer that in particular interacts with a camera.

10. The dental color key as claimed in claim 1, wherein the color key (10) and the buccal and/or labial surface area (26) of the tooth that is to be analyzed substantially extend into the same plane.

11. The dental color key as claimed in claim 1, wherein the color key is releasably mounted either mechanically or adhesively on at least one tooth or between at least two teeth of the upper jaw and the lower jaw.

12. The dental color key as claimed in claim 1, wherein the color key (10) has a thickness of 0.01 mm to 6 mm, and in particular is formed as a printed foil or film (44), which foil or film (44) is provided with an adhesive that can be removed from the tooth surface without leaving behind any remainder, i.e. in a residue-free manner.

13. The dental color key as claimed in claim 1, wherein at least the color patterns or samples (12) at least partially are made from ceramic material and/or a dental composite material.

14. The dental color key as claimed in claim 1, wherein the color patterns or samples (12) continuously merge or run together.

15. The dental color key as claimed in claim 1, wherein the color patterns or samples (12) do not continuously merge or run together but are represented in a discrete manner.
